(19) United States
(12) Patent Application Publication
(10) Pub. No.: US 2025/0258963 A1
(43) Pub. Date: Aug. 14, 2025

(54) CONFIDENTIAL COMPUTE ARCHITECTURE FOR SILICON INITIALIZATION FOR IP PROTECTION AND ASSURANCE

(71) Applicant: Intel Corporation, Santa Clara, CA (US)

(72) Inventors: Jiewen Yao, Shanghai (CN); Subrata Banik, Bangalore (IN); Rajesh Poornachandran, Portland, OR (US); Vincent Zimmer, Issaquah, WA (US)

(73) Assignee: Intel Corporation, Santa Clara, CA (US)

(21) Appl. No.: 18/855,184

(22) PCT Filed: May 31, 2022
(86) PCT No.: PCT/CN2022/096220

§ 371 Date: Oct. 8, 2024

(51) Int. Cl. G06F 21/64; G06F 21/10

(52) U.S. Cl. CPC G06F 21/64; G06F 21/107

(57) ABSTRACT

Embodiments are directed to utilizing a confidential compute architecture for silicon initialization for IP protection and assurance. An embodiment of a processing system includes a memory device communicably coupled to hardware components and to memory modules, the memory device to store platform initialization firmware to cause the processing system to execute a firmware hypervisor to initiate a trust domain (TD) of a confidential compute architecture, wherein the TD to provide confidentiality and integrity protection for data loaded in the TD; load IP firmware and an initial program loader (IPL) for the IP firmware in the TD, wherein the IP firmware corresponds to an IP component and is encrypted; obtain, by the IPL, an IP firmware key to decrypt the IP firmware in the TD; and execute an initialization process for the IP component using the decrypted IP firmware.

### FIELD

This disclosure relates generally to confidential computing and more particularly to a confidential compute architecture for silicon initialization for IP protection and assurance.

### BACKGROUND

A processing system may include hardware and software components. The software components may include one or more applications, an operating system (OS), and firmware. The applications may include control logic for performing the work that is of value to the user of the processing system. In the processing system, the applications run on top of the OS, which runs at a lower logical level than the applications (i.e., closer to the hardware) to provide an underlying environment or abstraction layer that makes it easier to create and execute the applications. The firmware runs at an even lower logical level to provide an underlying environment or abstraction layers which makes it easier to create and execute the OS. For instance, the firmware may establish a basic input/output system (BIOS), and the OS may use that BIOS to communicate with different hardware component within the processing system.

### BRIEF DESCRIPTION OF THE DRAWINGS

Embodiments described here are illustrated by way of example, and not by way of limitation, in the figures of the accompanying drawings in which like reference numerals refer to similar elements.

FIG. 1 illustrates a system on a chip (SoC) implementing a confidential compute architecture for silicon initialization for IP protection and assurance, according to implementations of the disclosure.

FIG. 2 illustrates a block diagram depicting a computing system providing a confidential compute architecture for silicon initialization for IP protection and assurance, in accordance with implementations of the disclosure.

FIG. 3 illustrates a block diagram depicting an IP initialization environment implementing a confidential compute architecture for silicon initialization for IP protection and assurance, in accordance with implementations of the disclosure.

FIG. 4 is a block diagram depicting an IP initialization environment implementing multiple TDs for silicon initialization for IP protection and assurance, in accordance with implementations of the disclosure.

FIG. 5 is a flow diagram illustrating operations for implementing confidential compute architecture for silicon initialization for IP protection and assurance, according to implementations of the disclosure.

FIG. 6 is a schematic diagram of an illustrative electronic computing device to enable confidential compute architecture for silicon initialization for IP protection and assurance, according to some implementations.

### DETAILED DESCRIPTION

Embodiments described herein are directed to a confidential compute architecture for silicon initialization for IP protection and assurance.

When a processing system is turned on or reset, the processing system may execute a boot process before the processing system can be utilized for work. As discussed herein, the operations for preparing a processing system to execute an OS may be referred to as the “boot process.” Similarly, the time that elapses during the boot process may be referred to as the “boot time.” The control logic or firmware that performs or controls the boot process may be referred to as the “system firmware,” the “system bootcode,” the “platform bootcode,” or simply the “bootcode.”

In conventional computing systems, such as a System-on-a-Chip (SoC), there are various platform components (also referred to herein as platform devices) that are enabled during the boot process. Platform components may refer to components that implement hardware functionality in a computing system and can include, but are not limited to, Universal Asynchronous Receiver/Transmitter (UART), Ethernet controllers, media access controllers (MACs), Peripheral Component Interconnect (PCI), PCI-express (PCI-E), processor units, power modules, USB modules, memory modules, and so on. The hardware circuit that is the basic building block of the platform component design and that is integrated into a system processing chip's core logic is referred to herein as semiconductor intellectual property (IP), or just simply as an “IP” or “IP block” herein.

In conventional computing systems, IPs for the computing system (e.g., SoC) are enabled during the boot process. This is because, in conventional systems, there is no way to enable/disable these IPs dynamically in a verified environment based on functional uses of the operating system (OS) during runtime. IPs can be enabled through hardware initialization code (e.g., Basic Input/Output System (BIOS) code) during the boot process itself. In some cases, the system firmware may support binary silicon IP distribution, such as a Scalable Firmware Supported Package (sFSP) Module binary.

Technologies like sFSP deliver the initialization code in a plaintext binary. However, a security issue arises as plaintext binary can be disassembled by any third party and the internal flow of the IP initialization can be discerned. Many SoC platforms are moving to IP-based initialization, with the IP modules being potentially sourced from 3^{rd} parties. Current approaches do not provide a way for third-party SoC IP providers to avoid disclosing IP. Instead, such third-party SoC IP providers have to trust the BIOS vendors, who obtain the IP initialization code in source form. This results in a potential insecure initialization environment for the SoC IP providers.

There are a few different conventional approaches to address the insecure initialization environment for SOC IP providers. A first conventional approach is to provide a BIOS guard module that is an encrypted module that supports secure BIOS updates. The BIOS guard module is decrypted by CPU in the cache inside of system management memory (SMM). With this approach, the BIOS Guard module utilizes the SMM to prepare the environment and load a binary in specialized RAM with all of the CPUs in a rendezvous state in SMM. After the BIOS module runs, the system restores the previous execution environment. This may be used for one-time initialization, but it is hard to provide runtime services with this approach.

A second conventional approach is to utilize encrypted firmware. A special Root-of-trust module should be used to decrypt the firmware and load it into internal memory for execution. A third conventional approach is offloading the IP firmware to a microcontroller. The microcontroller may have its own root-of-trust and key storage to decrypt the IP firmware. For the second and third approaches, the IP firmware should be loaded into a special microcontroller or device memory after decryption. The IP firmware plaintext should not be loaded into the host memory or accessible directly by the host CPU, which may lead to architecture complexity and cost increases.

Implementations herein address the above-described technical disadvantages of the conventional approaches by providing a confidential compute architecture for silicon initialization for IP protection and assurance. In embodiments herein, a confidential computing environment may include a Trust Domain Extensions (TDX) confidential computing environment. In some embodiments, a confidential computing environment may include other confidential computing architectures, such as secure encrypted virtualization (SEV).

TDX includes instructions in a CPU instruction set architecture (ISA) to remove a virtual machine monitor (VMM) from the trusted computing base (TCB) of cloud-computing virtual machine (VM) workloads (called Trust Domains or TDs). Generally, a TCB comprises a set of hardware, firmware, and software components that are implemented on a platform to provide a secure environment including a portion of the platform's memory address space that is used by the TCB.

In implementations herein, in order to protect the IP firmware execution flow, the sFSP binary, such as FSP-Memory (FSP-M) or FSP-silicon (FSPS), is placed into a special domain of a confidential compute architecture, such as trust domain (TD) of the TDX architecture. TDX is used to create the special TD for the SoC IP initialization and runtime services. The TD provides the confidentiality and integrity protection for the SoC IP code. The sFSP is allowed to perform the initialization with a secure arbitration module, such as a TDX module in Security Arbitration Mode (SEAM). The TDX module has a special Security Attribute of Initiator (SAI), which is granted by the hardware. It can access the silicon IP directly.

In implementations herein, the sFSP binary is encrypted when a lightweight firmware hypervisor (LFH) initializes the TD environment. An sFSP loader obtains an encryption key from a key service during runtime. The key service can be embedded in the SoC IP, such as in a Register Transfer Level (RTL), or in a security microcontroller (such as a Server Startup Secure Service Module (S3M), or an Enhanced Security Engine (ESE)). In some implementations, the key service can be in a remote server that is accessible via the cloud from a service Baseboard Management Controller (BMC). In order to ensure the key request is initiated from a known-good TD, mutual authentication is implemented between the TD IP firmware loader and the key services.

Implementations of the disclosure provide technical advantages including improving security of the SoC by securing the IP initialization process in the SoC for all IP vendors and also securing the runtime logic of those initialized IPs. This prevents unauthorized and untrusted access to the IP initialization firmware on the SoC.

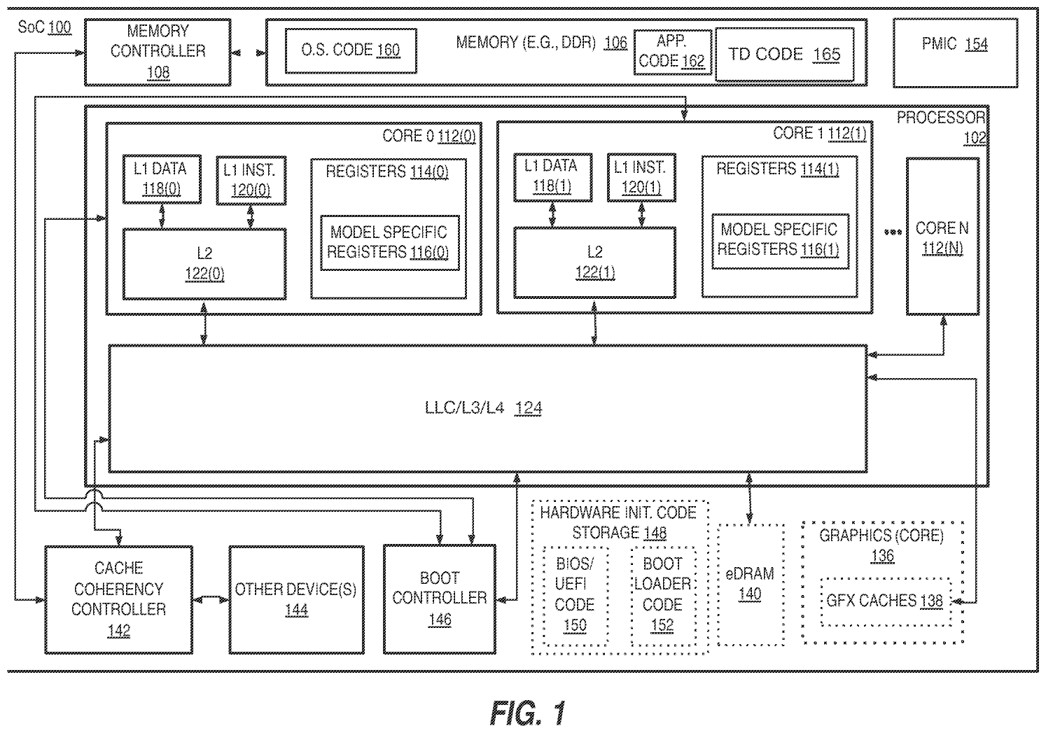

FIG. 1 illustrates a system on a chip (SoC) 100 implementing a confidential compute architecture for silicon initialization for IP protection and assurance, according to implementations of the disclosure. SoC 100 includes a boot controller 146. The boot controller 146 may be located within processor 102. Depicted SoC 100 illustrates a hardware processor 102 coupled to a memory 106 via memory controller 108. In one embodiment, the memory 106 of SoC 100 is a system memory (e.g., dynamic random-access memory (DRAM)). Memory controller 108 may be included, e.g., to manage memory requests between the processor 102 and memory 106. In one embodiment, memory controller 108 is to provide (e.g., fill) data (e.g., a cache line) for a miss in the cache(s) (e.g., miss in L3, L4, or other last level cache (LLC) 124 of processor 102).

Processor 102 may include one or more processor cores 112, e.g., 0 to N where N is a positive integer. In one embodiment, each of a plurality of processor cores have an instance of the circuitry discussed herein. Depicted core 0 112(0) includes a first level (L1) of data cache 118(0), a first level (L1) of instruction cache 120(0), and a level two (L2) cache 122(0). Depicted core 1 112(1) includes a first level (L1) of data cache 118(1), a first level (L1) of instruction cache 120(1), and a level two (L2) cache 122(1).

In some embodiments, as shown in FIG. 1, processor 102 includes one or more next levels of cache 124 (e.g., level three (L3) cache and level four (L4) cache e.g., with L4 the last level cache (LLC) (e.g., the last cache searched before a data item is fetched from memory 106) that is coupled to, and shared by, one or more (e.g., all) of the cores. In certain embodiments, each of L1 data caches 118, L1 instruction caches 120, L2 caches 122, LLC caches 124 (e.g., L3 cache and/or L4 cache) are managed by cache coherency controller 142 (e.g., circuitry), e.g., to cache data (e.g., and/or instructions) according to a specified cache coherency.

In certain embodiments, the data (e.g., and/or instructions) stored within the various processor caches are managed at the granularity of cache lines which may be a fixed size (e.g., 64, 128, 512, etc. Bytes in length). Each core 112 may include other components, for example, an instruction fetch circuit for fetching instructions (for example, from (e.g., main) memory 106 via a memory controller and/or from the caches; a decode circuit (e.g., decoder or decode unit) for decoding the instructions (e.g., decoding program instructions into micro-operations or “μops”); and an execution unit (e.g., execution circuit) for executing the decoded instructions. Core may include a writeback/retire circuit for retiring the instructions and writing back the results. Depicted core 0 112(0) further includes a set of one or more registers 114(0), for example, having one or more model specific registers 116(0), e.g., as control register(s).

SoC 100 may include one or more other devices 144, (e.g., any device to be initialized before DRAM initialization is attached with cache, such as CSME, GSPI, ESPI, etc.) that are also coupled to cache coherency controller 142. SoC 100 may include graphics circuitry 136 (e.g., a graphics core). In certain embodiments, graphics circuitry 136 includes one or more caches 138, e.g., that are coupled to one or more caches shared with the processor, e.g., L3 cache and/or L4 cache 124. SoC 100 may include an embedded dynamic random-access memory 140 (eDRAM), for example, embedded into SoC 100 with processor 102. In certain embodiments, eDRAM 140 is used as L4 (e.g., LLC) cache 124 (e.g., instead of using an embedded static RAM (eSRAM) for the L4 cache). In certain embodiments, eDRAM 140 is positioned between L3 cache 124 and memory 106 (e.g., DRAM (e.g., Double Data Rate Synchronous DRAM (DDR)), e.g., on a memory bus. SoC 100 may include a power management integrated circuit 154 (PMIC), e.g., to, in response to a power on indication (e.g., pressing of a mechanical on/off switch), provide (e.g., power to the components of the SoC 100.

In certain embodiments, SoC 100 (e.g., internal or external to processor 102) includes hardware initialization code storage 148. The hardware initialization code may be hardware initialization firmware. In certain embodiments, the hardware initialization code from storage 148, when executed by the processor 102, is to cause the booting up of the SoC 100 (e.g., at least the booting up of the hardware processor 102 thereof).

In certain embodiments, the hardware initialization code is responsible for transferring control of the computer (e.g., SoC 100) to a program (e.g., OS) stored in memory coupled to the computer.

In certain embodiments, the hardware initialization code storage 148 includes BIOS and/or UEFI code from storage 150 and boot loader code from storage 152. In certain of those embodiments, the BIOS and/or UEFI (e.g., boot ROM) code is executed as a first stage, and then the boot loader code is executed as a second stage. As one example, BIOS code is according to a BIOS standard. As another example, UEFI code is according to a UEFI standard. Other embodiments of BIOS include Universal Scalable Firmware (USF), Slim Bootloader, Coreboot, Tianocore, and U-Boot, to name a few examples. In some embodiments, such as for silicon abstraction, implementations can include binary encapsulations such as the Intel® Firmware Support Package (FSP) in addition to other binary embodiments, such as other Intel® x86, RISC-V, or ARM-based boot ROMs.

In certain embodiments, the BIOS and/or UEFI code brings the SoC 100 (e.g., processor 102 thereof) out of (e.g., cold) reset, puts the processor into a known and stable state, and finds the second-stage boot loader code (e.g., from storage 152) and passes control to the next stage. In one embodiment, the BIOS and/or UEFI (e.g., boot ROM) code is aware of the second-stage boot loader code 152 and not aware of any potential subsequent software stages. In certain embodiments, during this time, the BIOS and/or UEFI (e.g., boot ROM) code handles any error conditions.

In certain embodiments, the boot loader code (e.g., being passed control of the SoC (e.g., processor) when the BIOS and/or UEFI code stage is complete) then locates and loads (e.g., for execution by the processor) the next stage(s) of software (e.g., O.S.) and so on. In one embodiment, before control is passed to the boot loader code, it is decrypted and/or authenticated if secure boot is enabled.

In certain embodiments, BIOS and/or UEFI (e.g., boot ROM) code, when executed, initializes certain hardware of the SoC, checks integrity, and initializes the (e.g., first level) boot loader code. In certain embodiments, the boot loader code is, e.g., after being called at the completion of BIOS and/or UEFI (e.g., boot ROM) code execution, executed to cause a handoff of control of the SoC (e.g., processor) to the operating system executing of the SoC. In one embodiment, the boot loader code knows where (e.g., the memory location of) the OS kernel image is stored in memory, for example, and loads the OS kernel image for execution.

Although BIOS and/or UEFI (e.g., boot ROM) code storage 150 and boot loader code storage 152 are shown together, in another embodiment the BIOS and/or UEFI (e.g., boot ROM) code storage 150 is within processor 102 and the boot loader code storage 152 is separate from the processor 102 (e.g., in storage 148 of SoC 100).

In implementations of the disclosure, the BIOS and/or UEFI (e.g., boot ROM) code 150 include IP firmware binary code, such as an encrypted scalable firmware support package (sFSP) module binary code, that is utilized to initialize one or more IP blocks of the SoC 100. During the initialization (boot) sequence of the SoC, TD code 165 can enable a lightweight firmware hypervisor (LFH) to initialize a confidential compute environment, such as a TD of the TDX architecture. Although implementations herein are discussed in terms of utilizing TDs and the TDX architecture, other types of confidential compute architectures may be utilized in implementations herein, such as Intel's® Software Guard Extensions (SGX), AMD's® Secure Encrypted Virtualization (SEV), ARM's® Realm, and so on.

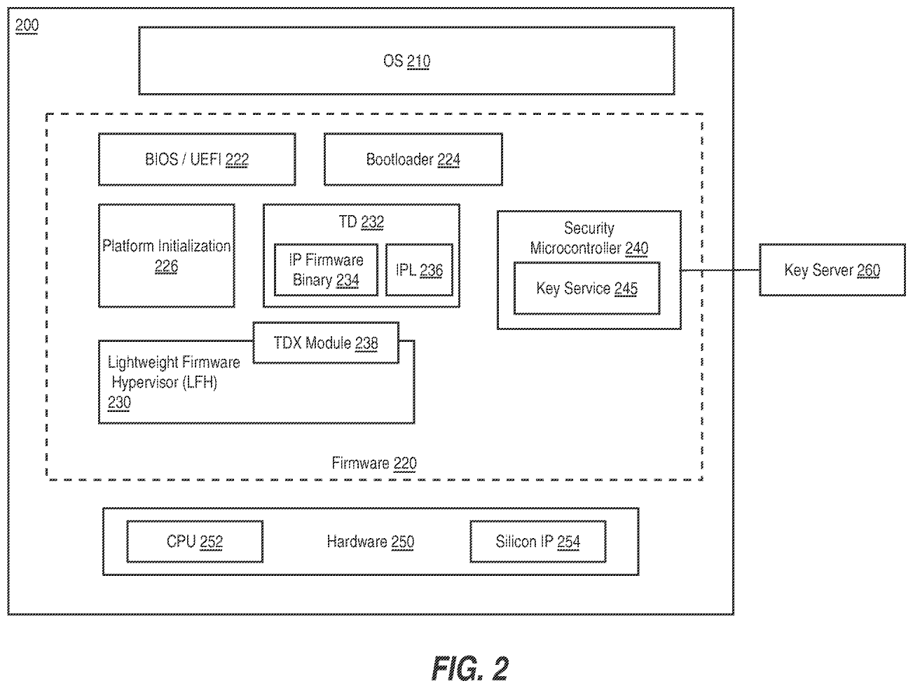

The LFH loads the IP firmware binary code, including the encrypted IP initialization firmware, and an initial program loader (IPL) into TD. The IPL can interface with a TDX module of the TDX architecture to enable the IPL to decrypt the IP firmware binary code and allow the IP firmware binary code to perform the initialization of the IP blocks of SoC in a secure and verified manner. Turning now to FIG. 2, an example computing environment for an SoC IP block initialization process in accordance with implementations of the disclosure is depicted.

FIG. 2 illustrates a block diagram depicting a computing system 200 providing a confidential compute architecture for silicon initialization for IP protection and assurance, in accordance with implementations of the disclosure. In one implementation, the computing system 200 is the same as SoC 100 described with respect to FIG. 1. As shown in FIG. 2, computing system 200 includes an OS 210, firmware 220, and hardware 250. Computing system 200 is shown implementing a confidential compute architecture, such as a TDX architecture, in one implementation. As illustrated in the FIG. 2, the computing system 200 powers on and Host-Firmware (e.g., BIOS) 220 begins running over the processor (e.g., CPU 252, GPU, XPU, data processing unit (IPU), infrastructure processing unit (IPU), etc.) of hardware 250. Although the discussion herein may specifically refer to utilization of a CPU, any other type of processing unit may be utilized by embodiments herein, such as a GPU, XPU, DPU, IPU, hardware accelerator, and so on.

In one implementation, firmware 220 includes BIOS/UEFI 222 and bootloader 224 to enable a platform initialization 226 of the computing system 200. In one implementation, BIOS/UEFI 222 is the same as BIOS/UEFI code 150 of FIG. 1 and bootloader 224 is the same as bootloader code 152 of FIG. 1. The BIOS/UEFI 222 can bring the computing system 200 out a reset (e.g., power on), put the computing system 200 into a known and stable state, and find the bootloader 224 code to continue the platform initialization 226. As part of the initialization process, IP initialization firmware binary 234 can be executed to initialize one or more IP blocks of the computing system, such as silicon IP 254 of hardware 250.

Implementations of the disclosure provide an IP block initialization process for computing system 200 by implementing a confidential compute architecture for secure and verified initialization of IP firmware binary code 234. Implementations herein focus on the confidentiality and integrity protection of such IP firmware binary code 234.

In one implementation, the BIOS and/or UEFI (e.g., boot ROM) 222 code includes an encrypted version of IP firmware binary code, such as an encrypted sFSP binary code, that can be utilized to initialize one or more IP blocks 254 of the computing system 200. During the platform initialization 226 (boot) sequence of the computing system 200, the platform initialization 226 causes an LFH 230 to be initiated which provides a confidential compute environment, such as a TD 232 of the TDX architecture. As previously noted, although implementations herein are discussed in terms of utilizing TDs and the TDX architecture, other types of confidential compute architectures may be utilized in implementations herein, such as Intel's® Software Guard Extensions (SGX), AMD's® Secure Encrypted Virtualization (SEV), ARM's® Realm, and so on. The scalable

The LFH 230 loads the IP firmware binary code 234, including the encrypted IP initialization firmware into the TD 232, and an IPL 236 into the TD 232. The IPL 236 can then interface with a TDX module 238 (of the TDX architecture) hosted by the LFH 230 to cause the IP firmware binary code 234 to be decrypted. In one implementation, the IPL 236 interfaces, via the TDX module 238, with a key service 245 of a security microcontroller 240 (or with an external key server 260) to obtain an encryption key to decrypt the IP firmware binary 234. Once decrypted by the IPL 236, the IP firmware binary 234 can continue with the initialization process of the IP blocks 254 of computing system 200 in a secure and verified manner.

In implementations of the disclosure, the IP firmware binary 234 can be considered as data that is to be protected as various stages of the data cycle, including data at rest, data in transition, and data in use. With respect to data at rest, this refers to the IP firmware binary 234 itself. The IP firmware binary 234 is encrypted when it is initially provided (e.g., from the manufacturer). As noted above, an encryption key should be obtained from a trusted key service in order to decrypt the IP firmware binary 234.

With respect to data in transition, this refers to the encryption key provided from the key service 245. Mutual authentication and session encryption can be utilized when the key is transferred from the key service 245 to the TD 232. An authorized IPL 236 can get the key to decrypt the IP firmware binary 234.

With respect to data in use, this refer to the IP firmware execution code or data structures decrypted in the TD 232. The memory is protected by the TDX architecture. Outside of the TD 232, no one can read or write the TD memory.

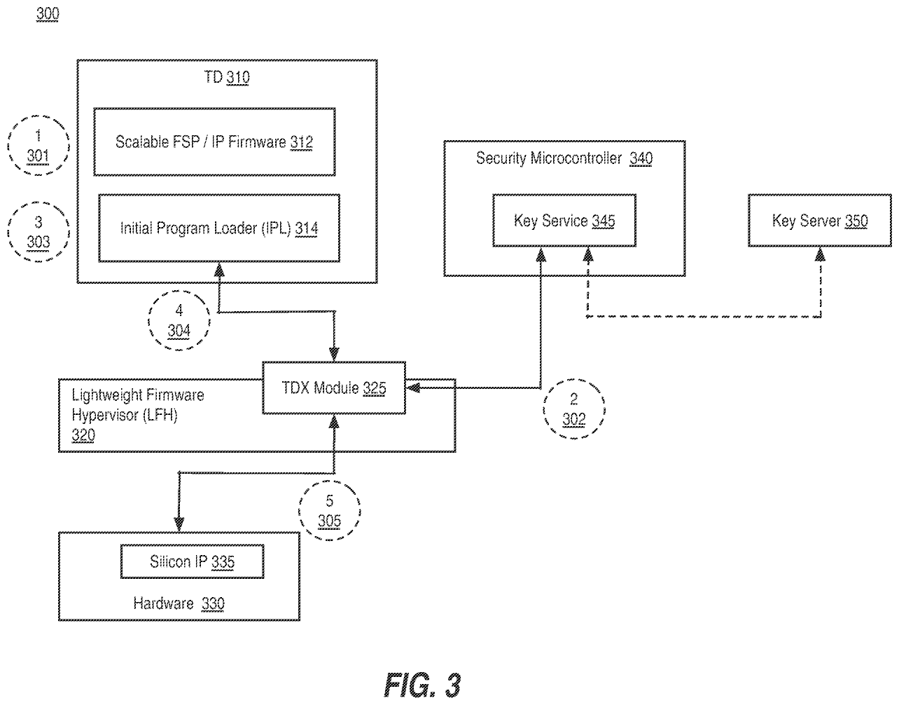

FIG. 3 illustrates a block diagram depicting an IP initialization environment 300 implementing a confidential compute architecture for silicon initialization for IP protection and assurance, in accordance with implementations of the disclosure. In one implementation, the IP initialization environment 300 is part of the SoC 100 described with respect to FIG. 1 and/or computing system 200 described with respect to FIG. 2. As shown in FIG. 3, IP initialization environment 300 includes a TD 310, LFH 320, hardware 330, and security microcontroller 340. In some implementations, components of IP initialization environment 300 may the same as the identically-named counterparts described with respect to FIGS. 1 and 2.

IP initialization environment 300 is shown implementing a confidential compute architecture, such as a TDX architecture, in one implementation. In one implementation, the confidential compute architecture enables a secure IP initialization flow to initialize silicon IP 335 of hardware 330, as shown in FIG. 3. At a first step 301, the LFH 320 loads the sFSP (collection of IP firmware binaries) 312, including the encrypted IP firmware inside of sFSP, and an IPL 314 into the TD 310. The IPL 314 may be a silicon-agnostic component in plaintext, while the sFSP/IP firmware 312 are encrypted with a silicon-specific symmetric key. At step 301, a TDX module 325 in SEAM extends the IPL 314 into TD measurement register (MRTD). Then, the IPL 314 can extend the sFSP/IP firmware 312 into a runtime measurement register (RTMR). Both the MRTD and the RTMR are the evidence of TD.

At a second step 302, the IPL 314 is to communicate with a key service 345 of a security microcontroller 340 in order to retrieve the key to decrypt the sFSP/IP firmware 312. The key service 345 can be implementation specific as long as it is provided by the same sFSP/IP firmware provider. For example, the key service 345 can be embedded in the security microcontroller 340 (e.g., a server Secure Startup Service module (S3M) or client Enhanced Security Engine (ESE)).

In one example implementation, the IPL 314 can setup a Secure Protocol and Data Model (SPDM) connection with the security microcontroller 340 to utilize in communicating the key to decrypt the sFSP/IP firmware 312. The IPL 314 can be an SPDM requester and security microcontroller 340 can be an SPDM responder. The IPL 314 can be provisioned with a security microcontroller certificate. In that case, the IPL 314 can verify the security microcontroller 340 during the SPDM session setup. The message in the SPDM session is encrypted and authenticated with a message authentication code (MAC). As a result, other entities cannot read or modify the SPDM message in a session in a fashion similar to network transport layer security (TLS) session.

Once there is an SPDM session setup between the IPL 314 and the security microcontroller 340, the security microcontroller 340 should verify the IPL 314. The IPL can pass a TD report (including the MRTD, RTMR and a MAC with the CPU key) to the security microcontroller 340. The security microcontroller 340 can verify the integrity of the TD report by checking the MAC of the TD report. Then, the security microcontroller 340 can verify the MRTD to see if the IPL 314 is authorized. After the security microcontroller 340 verifies the IPL 314, the security microcontroller 340 can pass the encryption key to the IPL 314 within the SPDM session.

In another example implementation, the security microcontroller 340 may be implemented as a baseboard management controller (BMC) and the IPL 314 may communicate with a key service broker (key service 245) in the BMC. The BMC key service broker (e.g., key service 345) can use a TLS session to communication with a remote key server 350 in a cloud environment. In one implementation, the key server 350 may use a standard TDX Quote verification to authenticate the TD report/Quote. After the remote key server 350 verifies the TD report/quote, it may pass the key to the IPL 314. The network TLS session is used between the remote key server 350 and IPL 314 via the BMC key service broker (e.g., key service 345 of security microcontroller 340).

At a third step 303, once the IPL 314 obtains the key, the IPL 314 can decrypt the sFSP/IP firmware 312. Then, the IPL 314 can erase the key and jump to an entry point of the sFSP/IP firmware 312.

At a fourth step 304, after the sFSP/IP firmware 312 is decrypted, it can perform silicon IP 335 initialization and/or provide runtime services. In this case, the sFSP/IP firmware 312 can use a SEAM call to the TDX module 325 for the register programming. In order to reduce the programming effort to trap every MMIO/IO access, the sFSP/IP firmware 312 can pass a register programming script table to the TDX module 325 to support batch programming. Table 1 below illustrates an example of such a register script table.

TABLE 1
Register Script Table

MMIO Write32 Addr: 0x800F004: Data: 0x7
MMIO Write32 Addr: 0x800F008: Data: 0xF000
MMIO Or16 Addr: 0x80100DC: Data: 0x3030
MMIO Or32 Addr: 0x8020040: Data: 0xA007 (Dummy)
MMIO And8 Addr: 0x8010049: Data: 0x5
. . .

In some implementations, in order to support obfuscation, the IP provider (IP vendor) may add one or more “dummy entries” in the register script table. These dummy entries do not have any real impact for the IP initialization or runtime workload, but they can bring some confusion to thwart any potential malicious attacker that tries to monitor the system behavior.

At a fifth step 305, the TDX module 325 can provide a policy setup to prevent the register programming SEAM call from originating from any arbitrary TD. In this case, the SEAM can check the RTMR and allow the register programming SEAM call from the TD 310 supporting the sFSP/IP firmware 312 initialization codes.

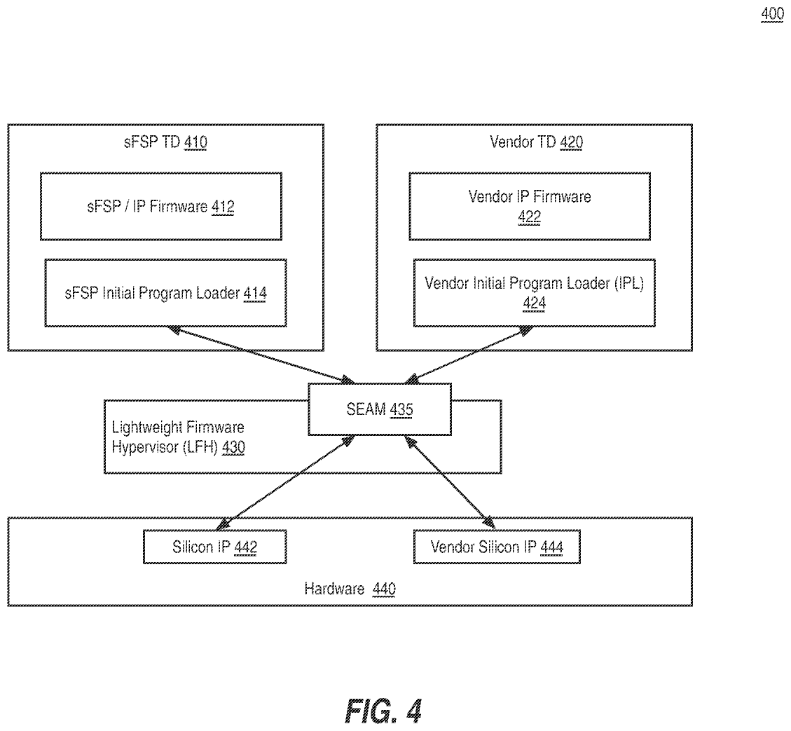

FIG. 4 is a block diagram depicting an IP initialization environment 400 implementing multiple TDs for silicon initialization for IP protection and assurance, in accordance with implementations of the disclosure. In one implementation, the IP initialization environment 400 is the same as IP initialization environment 300 described with respect to FIG. 3. As shown in FIG. 4, IP initialization environment 400 includes a sFSP TD 410, vendor TD 420, LFH 430, and hardware 440. In some implementations, components of IP initialization environment 400 may the same as the identically-named counterparts described with respect to FIG. 3.

IP initialization environment 400 illustrates that extension of the confidential compute architecture to establish multiple TDs for secure initialization of IP firmware. For example, hardware 440 may include multiple IP blocks, including an original silicon IP 442 (e.g., OEM's IP block), as well as third-party vendor IP blocks, such as vendor silicon IP 444. If the vendor seeks to protect their own IP block, such as vendor silicon IP 444, a separate vendor IPL 424 can be setup for the vendor IP firmware 422, which is different from the sFSP/IP firmware 412. Multiple TDs 410, 420 can be initiated for each IP firmware 412, 422 and corresponding IPLs 414, 424. The IPLs 414, 424 can each communicate with the SEAM 435 module of LFH 430 to obtain separate keys to decrypt the IP firmware 412, 422. The establishment of separate TDs 410, 420 can protect against the situation where there is a vulnerability in either of the TDs 410, 420. Such a vulnerability would not impact the other TDs 410, 420 in this case.

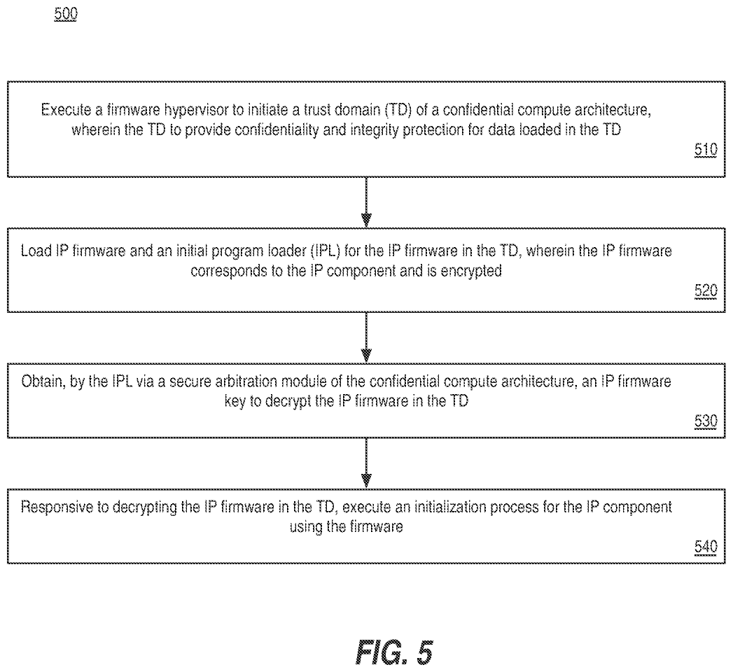

FIG. 5 is a flow diagram illustrating operations 500 for implementing confidential compute architecture for silicon initialization for IP protection and assurance, according to implementations of the disclosure. Some or all of the operations 500 (or other processes described herein, or variations, and/or combinations thereof) are performed under the control of one or more computer components configured to execute and are implemented as code (e.g., executable instructions, one or more computer programs, or one or more applications). The code is stored on a computer-readable storage medium, for example, in the form of a computer program comprising instructions executable by one or more processors. The computer-readable storage medium is non-transitory. In some embodiments, one or more (or all) of the operations 500 are performed by a boot service.

The operations 500 include, at block 510, where a processing device may execute a firmware hypervisor to initiate a trust domain (TD) of a confidential compute architecture. In one implementation, the TD is to provide confidentiality and integrity protection for data loaded in the TD. At block 520, the processing device may load IP firmware and an initial program loader (IPL) for the IP firmware in the TD. In one implementation, the IP firmware may correspond to the IP component and is encrypted.

Subsequently, at block 530, the processing device may obtain, by the IPL via a secure arbitration module of the confidential compute architecture, an IP firmware key to decrypt the IP firmware in the TD. Lastly, at block 540, the processing device may, responsive to decrypting the IP firmware in the TD, execute an initialization process for the IP component using the firmware.

Some of the operations illustrated in FIG. 5 may be repeated, combined, modified or deleted where appropriate, and additional steps may also be added to the flow in various embodiments. Additionally, steps may be performed in any suitable order without departing from the scope of particular embodiments.

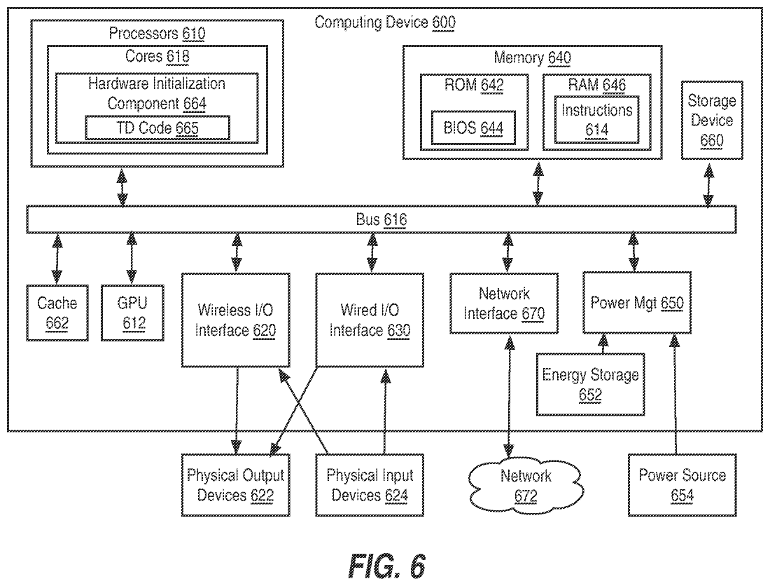

FIG. 6 is a schematic diagram of an illustrative electronic computing device to enable confidential compute architecture for silicon initialization for IP protection and assurance, according to some implementations. In some implementations, the computing device 600 includes one or more processors 610 including one or more processors dies (e.g., cores) 618 each including a hardware initialization component 664, such as a component to execute TD code to provide a confidential compute architecture for silicon initialization for IP protection and assurance, as described with respect to FIGS. 1-6. In some embodiments, the computing device is to provide confidential compute architecture for silicon initialization for IP protection and assurance using an TD code 665 of the hardware initialization component 664, as provided in FIGS. 1-6.

The computing device 600 may additionally include one or more of the following: cache 662, a graphical processing unit (GPU) 612 (which may be the hardware accelerator in some implementations), a wireless input/output (I/O) interface 620, a wired I/O interface 630, system memory 640 (e.g., memory circuitry), power management circuitry 650, non-transitory storage device 660, and a network interface 670 for connection to a network 672. The following discussion provides a brief, general description of the components forming the illustrative computing device 600. Example, non-limiting computing devices 600 may include a desktop computing device, blade server device, workstation, or similar device or system.

In embodiments, the processor cores 618 are capable of executing machine-readable instruction sets 614, reading data and/or instruction sets 614 from one or more storage devices 660 and writing data to the one or more storage devices 660. Those skilled in the relevant art will appreciate that the illustrated embodiments as well as other embodiments may be practiced with other processor-based device configurations, including portable electronic or handheld electronic devices, for instance smartphones, portable computers, wearable computers, consumer electronics, personal computers (“PCs”), network PCs, minicomputers, server blades, mainframe computers, and the like.

The processor cores 618 may include any number of hardwired or configurable circuits, some or all of which may include programmable and/or configurable combinations of electronic components, semiconductor devices, and/or logic elements that are disposed partially or wholly in a PC, server, or other computing system capable of executing processor-readable instructions.

The computing device 600 includes a bus or similar communications link 616 that communicably couples and facilitates the exchange of information and/or data between various system components including the processor cores 618, the cache 662, the graphics processor circuitry 612, one or more wireless I/O interfaces 620, one or more wired I/O interfaces 630, one or more storage devices 660, and/or one or more network interfaces 670. The computing device 600 may be referred to in the singular herein, but this is not intended to limit the embodiments to a single computing device 600, since in certain embodiments, there may be more than one computing device 600 that incorporates, includes, or contains any number of communicably coupled, collocated, or remote networked circuits or devices.

The processor cores 618 may include any number, type, or combination of currently available or future developed devices capable of executing machine-readable instruction sets.

The processor cores 618 may include (or be coupled to) but are not limited to any current or future developed single-or multi-core processor or microprocessor, such as: on or more systems on a chip (SOCs); central processing units (CPUs); digital signal processors (DSPs); graphics processing units (GPUs); application-specific integrated circuits (ASICs), programmable logic units, field programmable gate arrays (FPGAs), and the like. Unless described otherwise, the construction and operation of the various blocks shown in FIG. 6 are of conventional design. Consequently, such blocks are not described in further detail herein, as they should be understood by those skilled in the relevant art. The bus 616 that interconnects at least some of the components of the computing device 600 may employ any currently available or future developed serial or parallel bus structures or architectures.

The system memory 640 may include read-only memory (“ROM”) 642 and random access memory (“RAM”) 646. A portion of the ROM 642 may be used to store or otherwise retain a basic input/output system (“BIOS”) 644. The BIOS 644 provides basic functionality to the computing device 600, for example by causing the processor cores 618 to load and/or execute one or more machine-readable instruction sets 614. In embodiments, at least some of the one or more machine-readable instruction sets 614 cause at least a portion of the processor cores 618 to provide, create, produce, transition, and/or function as a dedicated, specific, and particular machine, for example a word processing machine, a digital image acquisition machine, a media playing machine, a gaming system, a communications device, a smartphone, or similar.

The computing device 600 may include at least one wireless input/output (I/O) interface 620. The at least one wireless I/O interface 620 may be communicably coupled to one or more physical output devices 622 (tactile devices, video displays, audio output devices, hardcopy output devices, etc.). The at least one wireless I/O interface 620 may communicably couple to one or more physical input devices 624 (pointing devices, touchscreens, keyboards, tactile devices, etc.). The at least one wireless I/O interface 620 may include any currently available or future developed wireless I/O interface. Example wireless I/O interfaces include, but are not limited to: BLUETOOTH®, near field communication (NFC), and similar.

The computing device 600 may include one or more wired input/output (I/O) interfaces 630. The at least one wired I/O interface 630 may be communicably coupled to one or more physical output devices 622 (tactile devices, video displays, audio output devices, hardcopy output devices, etc.). The at least one wired I/O interface 630 may be communicably coupled to one or more physical input devices 624 (pointing devices, touchscreens, keyboards, tactile devices, etc.). The wired I/O interface 630 may include any currently available or future developed I/O interface. Example wired I/O interfaces include, but are not limited to, universal serial bus (USB), IEEE 1394 (“FireWire”), and similar.

The computing device 600 may include one or more communicably coupled, non-transitory, data storage devices 660. The data storage devices 660 may include one or more hard disk drives (HDDs) and/or one or more solid-state storage devices (SSDs). The one or more data storage devices 660 may include any current or future developed storage appliances, network storage devices, and/or systems. Non-limiting examples of such data storage devices 660 may include, but are not limited to, any current or future developed non-transitory storage appliances or devices, such as one or more magnetic storage devices, one or more optical storage devices, one or more electro-resistive storage devices, one or more molecular storage devices, one or more quantum storage devices, or various combinations thereof. In some implementations, the one or more data storage devices 660 may include one or more removable storage devices, such as one or more flash drives, flash memories, flash storage units, or similar appliances or devices capable of communicable coupling to and decoupling from the computing device 600.

The one or more data storage devices 660 may include interfaces or controllers (not shown) communicatively coupling the respective storage device or system to the bus 616. The one or more data storage devices 660 may store, retain, or otherwise contain machine-readable instruction sets, data structures, program modules, data stores, databases, logical structures, and/or other data useful to the processor cores 618 and/or graphics processor circuitry 612 and/or one or more applications executed on or by the processor cores 618 and/or graphics processor circuitry 612. In some instances, one or more data storage devices 660 may be communicably coupled to the processor cores 618, for example via the bus 616 or via one or more wired communications interfaces 630 (e.g., Universal Serial Bus or USB); one or more wireless communications interfaces 620 (e.g., Bluetooth®, Near Field Communication or NFC); and/or one or more network interfaces 670 (IEEE 802.3 or Ethernet, IEEE 802.11, or Wi-Fi®, etc.).

Processor-readable instruction sets 614 and other programs, applications, logic sets, and/or modules may be stored in whole or in part in the system memory 640. Such instruction sets 614 may be transferred, in whole or in part, from the one or more data storage devices 660. The instruction sets 614 may be loaded, stored, or otherwise retained in system memory 640, in whole or in part, during execution by the processor cores 618 and/or graphics processor circuitry 612.

The computing device 600 may include power management circuitry 650 that controls one or more operational aspects of the energy storage device 652. In embodiments, the energy storage device 652 may include one or more primary (i.e., non-rechargeable) or secondary (i.e., rechargeable) batteries or similar energy storage devices. In embodiments, the energy storage device 652 may include one or more supercapacitors or ultracapacitors. In embodiments, the power management circuitry 650 may alter, adjust, or control the flow of energy from an external power source 654 to the energy storage device 652 and/or to the computing device 600. The power source 654 may include, but is not limited to, a solar power system, a commercial electric grid, a portable generator, an external energy storage device, or any combination thereof.

For convenience, the processor cores 618, the graphics processor circuitry 612, the wireless I/O interface 620, the wired I/O interface 630, the storage device 660, and the network interface 670 are illustrated as communicatively coupled to each other via the bus 616, thereby providing connectivity between the above-described components. In alternative embodiments, the above-described components may be communicatively coupled in a different manner than illustrated in FIG. 6. For example, one or more of the above-described components may be directly coupled to other components, or may be coupled to each other, via one or more intermediary components (not shown). In another example, one or more of the above-described components may be integrated into the processor cores 618 and/or the graphics processor circuitry 612. In some embodiments, all or a portion of the bus 616 may be omitted and the components are coupled directly to each other using suitable wired or wireless connections.

The following examples pertain to further embodiments. Example 1 is a processing system to facilitate a confidential compute architecture for silicon initialization for IP protection and assurance. The processing system of Example 1 comprises a plurality of hardware components comprising an intellectual property (IP) component; one or more memory modules; and a memory device communicably coupled to the plurality of hardware components and the one or more memory modules, the memory device to store platform initialization firmware to cause the processing system to: execute a firmware hypervisor to initiate a trust domain (TD) of a confidential compute architecture, wherein the TD to provide confidentiality and integrity protection for data loaded in the TD; load IP firmware and an initial program loader (IPL) for the IP firmware in the TD, wherein the IP firmware corresponds to the IP component and is encrypted; obtain, by the IPL, an IP firmware key to decrypt the IP firmware in the TD; and responsive to decrypting the IP firmware in the TD, execute an initialization process for the IP component using the IP firmware.

In Example 2, the subject matter of Example 1 can optionally include wherein the hardware initialization firmware is according to a Basic Input/Output System standard. In Example 3, the subject matter of any one of Examples 1-2 can optionally include wherein the hardware initialization firmware is according to a Unified Extensible Firmware Interface standard. In Example 4, the subject matter of any one of Examples 1-3 can optionally include wherein the confidential compute architecture comprises at least one of a trust domain extensions (TDX) confidential compute architecture, a software guard extensions (SGX) confidential compute architecture, a secure encrypted virtualization architecture (SEV) confidential compute architecture, or a Realm confidential compute architecture.

In Example 5, the subject matter of any one of Examples 1-4 can optionally include wherein the IP firmware key is obtained from a secure arbitration module of the confidential compute architecture, wherein the secure arbitration module is to extend the IPL into a TD measurement register (MRTD), and wherein the IPL extends the IP firmware into a runtime measurement register (RTMR), the MRTD and the RTMR providing evidence of the TD in a TD report. In Example 6, the subject matter of any one of Examples 1-5 can optionally include wherein the TD report enables a security microcontroller of the processing system to verify the IPL in the TD. In Example 7, the subject matter of any one of Examples 1-6 can optionally include as part of the initialization process, the IP firmware to transmit a register programming script table to a secure arbitration module of the confidential compute architecture, the register programming script table to enable the secure arbitration module to perform the initialization process for the IP component.

In Example 8, the subject matter of any one of Examples 1-7 can optionally include wherein the register programming script table comprises at least one dummy register access to support obfuscation. In Example 9, the subject matter of any one of Examples 1-8 can optionally include wherein the key is stored in a security microcontroller of the processing system.

In Example 10, the subject matter of any one of Examples 1-9 can optionally include wherein the key is stored in a remote key service accessible by a security microcontroller of the processing system. In Example 11, the subject matter of any one of Examples 1-10 can optionally include wherein a TD is established for each vendor of each IP component of the processing system. In Example 12, the subject matter of any one of Examples 1-11 can optionally include wherein the secure arbitration module comprises a policy control to enable special services to the TD.

Example 13 is a method for facilitating a confidential compute architecture for silicon initialization for IP protection and assurance. The method of Example 13 can include executing, by a processing device of a processing system, a firmware hypervisor to initiate a trust domain (TD) of a confidential compute architecture, wherein the TD to provide confidentiality and integrity protection for data loaded in the TD; loading Intellectual Property (IP) firmware and an initial program loader (IPL) for the IP firmware in the TD, wherein the IP firmware corresponds to an IP component of the processing system and is encrypted; obtaining, by the IPL, an IP firmware key to decrypt the IP firmware in the TD; and responsive to decrypting the IP firmware in the TD, executing an initialization process for the IP component using the IP firmware.

In Example 14, the subject matter of Example 13 can optionally include wherein the confidential compute architecture comprises at least one of a trust domain extensions (TDX) confidential compute architecture, a software guard extensions (SGX) confidential compute architecture, a secure encrypted virtualization architecture (SEV) confidential compute architecture, or a Realm confidential compute architecture. In Example 15, the subject matter of Examples 13-14 can optionally include wherein the IP firmware key is obtained from a secure arbitration module of the confidential compute architecture, wherein the secure arbitration module is to extend the IPL into a TD measurement register (MRTD), wherein the IPL extends the IP firmware into a runtime measurement register (RTMR), the MRTD and the RTMR providing evidence of the TD in a TD report, and wherein the TD report enables a security microcontroller of the processing system to verify the IPL in the TD.

In Example 16, the subject matter of Examples 13-15 can optionally include wherein as part of the initialization process, the IP firmware to transmit a register programming script table to a secure arbitration module of the confidential compute architecture, the register programming script table to enable the secure arbitration module to perform the initialization process for the IP component.

Example 17 is a non-transitory computer-readable storage medium for facilitating a confidential compute architecture for silicon initialization for IP protection and assurance. The non-transitory computer-readable storage medium of Example 17 having stored thereon executable computer program instructions that, when executed by one or more processors, cause the one or more processors to perform operations comprising: executing, by a processing device of the one or more processors of a processing system, a firmware hypervisor to initiate a trust domain (TD) of a confidential compute architecture, wherein the TD to provide confidentiality and integrity protection for data loaded in the TD; loading IP firmware and an initial program loader (IPL) for the IP firmware in the TD, wherein the IP firmware corresponds to an IP component of the processing system and is encrypted; obtaining, by the IPL, an IP firmware key to decrypt the IP firmware in the TD; and responsive to decrypting the IP firmware in the TD, executing an initialization process for the IP component using the IP firmware.

In Example 18, the subject matter of Example 17 can optionally include wherein the confidential compute architecture comprises at least one of a trust domain extensions (TDX) confidential compute architecture, a software guard extensions (SGX) confidential compute architecture, a secure encrypted virtualization architecture (SEV) confidential compute architecture, or a Realm confidential compute architecture. In Example 19, the subject matter of Examples 17-18 can optionally include wherein the IP firmware key is obtained from a secure arbitration module of the confidential compute architecture, wherein the secure arbitration module is to extend the IPL into a TD measurement register (MRTD), wherein the IPL extends the IP firmware into a runtime measurement register (RTMR), the MRTD and the RTMR providing evidence of the TD in a TD report, and wherein the TD report enables a security microcontroller to verify the IPL in the TD.

In Example 20, the subject matter of Examples 17-19 can optionally include wherein as part of the initialization process, the IP firmware to transmit a register programming script table to a secure arbitration module of the confidential compute architecture, the register programming script table to enable the secure arbitration module to perform the initialization process for the IP component.

Example 21 is a system for facilitating a confidential compute architecture for silicon initialization for IP protection and assurance. The system of Example 21 can optionally include a memory to store a block of data, and a processor communicably coupled to the memory to: execute a firmware hypervisor to initiate a trust domain (TD) of a confidential compute architecture, wherein the TD to provide confidentiality and integrity protection for data loaded in the TD; load Intellectual Property (IP) firmware and an initial program loader (IPL) for the IP firmware in the TD, wherein the IP firmware corresponds to an IP component of the system and is encrypted; obtain, by the IPL, an IP firmware key to decrypt the IP firmware in the TD; and responsive to decrypting the IP firmware in the TD, execute an initialization process for the IP component using the IP firmware.

In Example 22, the subject matter of Example 21 can optionally include wherein the hardware initialization firmware is according to a Basic Input/Output System standard. In Example 23, the subject matter of any one of Examples 21-22 can optionally include wherein the hardware initialization firmware is according to a Unified Extensible Firmware Interface standard. In Example 24, the subject matter of any one of Examples 21-23 can optionally include wherein the confidential compute architecture comprises at least one of a trust domain extensions (TDX) confidential compute architecture, a software guard extensions (SGX) confidential compute architecture, a secure encrypted virtualization architecture (SEV) confidential compute architecture, or a Realm confidential compute architecture.

In Example 25, the subject matter of any one of Examples 21-24 can optionally include wherein the IP firmware key is obtained from a secure arbitration module of the confidential compute architecture, wherein the secure arbitration module is to extend the IPL into a TD measurement register (MRTD), and wherein the IPL extends the IP firmware into a runtime measurement register (RTMR), the MRTD and the RTMR providing evidence of the TD in a TD report. In Example 26, the subject matter of any one of Examples 21-25 can optionally include wherein the TD report enables a security microcontroller of the processing system to verify the IPL in the TD. In Example 27, the subject matter of any one of Examples 21-26 can optionally include as part of the initialization process, the IP firmware to transmit a register programming script table to a secure arbitration module of the confidential compute architecture, the register programming script table to enable the secure arbitration module to perform the initialization process for the IP component.

In Example 28, the subject matter of any one of Examples 21-27 can optionally include wherein the register programming script table comprises at least one dummy register access to support obfuscation. In Example 29, the subject matter of any one of Examples 21-28 can optionally include wherein the key is stored in a security microcontroller of the processing system.

In Example 30, the subject matter of any one of Examples 21-29 can optionally include wherein the key is stored in a remote key service accessible by a security microcontroller of the processing system. In Example 31, the subject matter of any one of Examples 21-30 can optionally include wherein a TD is established for each vendor of each IP component of the processing system. In Example 32, the subject matter of any one of Examples 21-31 can optionally include wherein the secure arbitration module comprises a policy control to enable special services to the TD.

Example 33 is an apparatus for facilitating a confidential compute architecture for silicon initialization for IP protection and assurance, comprising means for executing a firmware hypervisor to initiate a trust domain (TD) of a confidential compute architecture, wherein the TD to provide confidentiality and integrity protection for data loaded in the TD; means for loading Intellectual Property (IP) firmware and an initial program loader (IPL) for the IP firmware in the TD, wherein the IP firmware corresponds to an IP component and is encrypted; means for obtaining, using the IPL, an IP firmware key to decrypt the IP firmware in the TD; and responsive to decrypting the IP firmware in the TD, means for executing an initialization process for the IP component using the IP firmware. In Example 34, the subject matter of Example 33 can optionally include the apparatus further configured to perform the method of any one of the Examples 14 to 16.

Example 35 is at least one machine readable medium comprising a plurality of instructions that in response to being executed on a computing device, cause the computing device to carry out a method according to any one of Examples 13-16. Example 36 is an apparatus for facilitating a confidential compute architecture for silicon initialization for IP protection and assurance, configured to perform the method of any one of Examples 13-16. Example 37 is an apparatus for facilitating a confidential compute architecture for silicon initialization for IP protection and assurance, comprising means for performing the method of any one of Examples 13-16. Specifics in the Examples may be used anywhere in one or more embodiments.

In the description above, for the purposes of explanation, numerous specific details are set forth in order to provide a thorough understanding of the described embodiments. It will be apparent, however, to one skilled in the art that embodiments may be practiced without some of these specific details. In other instances, well-known structures and devices are shown in block diagram form. There may be intermediate structure between illustrated components. The components described or illustrated herein may have additional inputs or outputs that are not illustrated or described.

Various embodiments may include various processes. These processes may be performed by hardware components or may be embodied in computer program or machine-executable instructions, which may be used to cause a general-purpose or special-purpose processor or logic circuits programmed with the instructions to perform the processes. Alternatively, the processes may be performed by a combination of hardware and software.

Portions of various embodiments may be provided as a computer program product, which may include a computer-readable medium (e.g., non-transitory computer-readable storage medium) having stored thereon computer program instructions, which may be used to program a computer (or other electronic devices) for execution by one or more processors to perform a process according to certain embodiments. The computer-readable medium may include, but is not limited to, magnetic disks, optical disks, read-only memory (ROM), random access memory (RAM), erasable programmable read-only memory (EPROM), electrically-erasable programmable read-only memory (EEPROM), magnetic or optical cards, flash memory, or other type of computer-readable medium suitable for storing electronic instructions. Moreover, embodiments may also be downloaded as a computer program product, wherein the program may be transferred from a remote computer to a requesting computer.

Many of the methods are described in their basic form, but processes can be added to or deleted from any of the methods and information can be added or subtracted from any of the described messages without departing from the basic scope of the present embodiments. It will be apparent to those skilled in the art that many further modifications and adaptations can be made. The particular embodiments are not provided to limit the concept but to illustrate it. The scope of the embodiments is not to be determined by the specific examples provided above but only by the claims below.

If it is said that an element “A” is coupled to or with element “B,” element A may be directly coupled to element B or be indirectly coupled through, for example, element C. When the specification or claims state that a component, feature, structure, process, or characteristic A “causes” a component, feature, structure, process, or characteristic B, it means that “A” is at least a partial cause of “B” but that there may also be at least one other component, feature, structure, process, or characteristic that assists in causing “B.” If the specification indicates that a component, feature, structure, process, or characteristic “may”, “might”, or “could” be included, that particular component, feature, structure, process, or characteristic is not required to be included. If the specification or claim refers to “a” or “an” element, this does not mean there is only one of the described elements.

An embodiment is an implementation or example. Reference in the specification to “an embodiment,” “one embodiment,” “some embodiments,” or “other embodiments” means that a particular feature, structure, or characteristic described in connection with the embodiments is included in at least some embodiments. The various appearances of “an embodiment,” “one embodiment,” or “some embodiments” are not all referring to the same embodiments. It should be appreciated that in the foregoing description of example embodiments, various features are sometimes grouped together in a single embodiment, figure, or description thereof for the purpose of streamlining the disclosure and aiding in the understanding of one or more of the various novel aspects. This method of disclosure, however, is not to be interpreted as reflecting an intention that the claimed embodiments utilize more features than are expressly recited in each claim. Rather, as the following claims reflect, novel aspects lie in less than all features of a single foregoing disclosed embodiment. Thus, the claims are hereby expressly incorporated into this description, with each claim standing on its own as a separate embodiment.

1. A processing system comprising:
a plurality of hardware components comprising an intellectual property (IP) component;
one or more memory modules; and
a memory device communicably coupled to the plurality of hardware components and the one or more memory modules, the memory device to store platform initialization firmware to cause the processing system to:
execute a firmware hypervisor to initiate a trust domain (TD) of a confidential compute architecture, wherein the TD to provide confidentiality and integrity protection for data loaded in the TD;
load IP firmware and an initial program loader (IPL) for the IP firmware in the TD, wherein the IP firmware corresponds to the IP component and is encrypted;
obtain, by the IPL, an IP firmware key to decrypt the IP firmware in the TD; and
responsive to decrypting the IP firmware in the TD, execute an initialization process for the IP component using the IP firmware.

2. The processing system of claim 1, wherein the hardware initialization firmware is according to at least one of a Basic Input/Output System standard or a Unified Extensible Firmware Interface standard.

3. The processing system of claim 1, wherein after the IP firmware is decrypted, the IP firmware is to provide runtime services.

4. The processing system of claim 1, wherein the confidential compute architecture comprises at least one of a trust domain extensions (TDX) confidential compute architecture, a software guard extensions (SGX) confidential compute architecture, a secure encrypted virtualization architecture (SEV) confidential compute architecture, or a Realm confidential compute architecture.

5. The processing system of claim 1, wherein the IP firmware key is obtained from a secure arbitration module of the confidential compute architecture, wherein the secure arbitration module is to extend the IPL into a TD measurement register (MRTD), and wherein the IPL extends the IP firmware into a runtime measurement register (RTMR), the MRTD and the RTMR providing evidence of the TD in a TD report.

6. The processing system of claim 5, wherein the TD report enables a security microcontroller of the processing system to verify the IPL in the TD.

7. The processing system of claim 1, wherein as part of the initialization process, the IP firmware to transmit a register programming script table to a secure arbitration module of the confidential compute architecture, the register programming script table to enable the secure arbitration module to perform the initialization process for the IP component.

8. The processing system of claim 7, wherein the register programming script table comprises at least one dummy register access to support obfuscation.

9. The processing system of claim 1, wherein the key is stored in a security microcontroller of the processing system.

10. The processing system of claim 1, wherein the key is stored in a remote key service accessible by a security microcontroller of the processing system.

11. The processing system of claim 1, wherein a TD is established for each vendor of each IP component of the processing system.

12. The processing system of claim 5, wherein the secure arbitration module comprises a policy control to enable special services to the TD.

13. A method comprising:
executing, by a processing device of a processing system, a firmware hypervisor to initiate a trust domain (TD) of a confidential compute architecture, wherein the TD to provide confidentiality and integrity protection for data loaded in the TD;
loading Intellectual Property (IP) firmware and an initial program loader (IPL) for the IP firmware in the TD, wherein the IP firmware corresponds to an IP component of the processing system and is encrypted;
obtaining, by the IPL, an IP firmware key to decrypt the IP firmware in the TD; and
responsive to decrypting the IP firmware in the TD, executing an initialization process for the IP component using the IP firmware.

14. The method of claim 13, wherein the confidential compute architecture comprises at least one of a trust domain extensions (TDX) confidential compute architecture, a software guard extensions (SGX) confidential compute architecture, a secure encrypted virtualization architecture (SEV) confidential compute architecture, or a Realm confidential compute architecture.

15. The method of claim 13, wherein the IP firmware key is obtained from a secure arbitration module of the confidential compute architecture, wherein the secure arbitration module is to extend the IPL into a TD measurement register (MRTD), wherein the IPL extends the IP firmware into a runtime measurement register (RTMR), the MRTD and the RTMR providing evidence of the TD in a TD report, and wherein the TD report enables a security microcontroller of the processing system to verify the IPL in the TD.

16. The method of claim 13, wherein as part of the initialization process, the IP firmware to transmit a register programming script table to a secure arbitration module of the confidential compute architecture, the register programming script table to enable the secure arbitration module to perform the initialization process for the IP component.

17. A non-transitory computer-readable storage medium having stored thereon executable computer program instructions that, when executed by one or more processors, cause the one or more processors to perform operations comprising:
executing, by a processing device of the one or more processors of a processing system, a firmware hypervisor to initiate a trust domain (TD) of a confidential compute architecture, wherein the TD to provide confidentiality and integrity protection for data loaded in the TD;
loading IP firmware and an initial program loader (IPL) for the IP firmware in the TD, wherein the IP firmware corresponds to an IP component of the processing system and is encrypted;
obtaining, by the IPL, an IP firmware key to decrypt the IP firmware in the TD; and
responsive to decrypting the IP firmware in the TD, executing an initialization process for the IP component using the IP firmware.

18. The non-transitory computer-readable storage medium of claim 17, wherein the confidential compute architecture comprises at least one of a trust domain extensions (TDX) confidential compute architecture, a software guard extensions (SGX) confidential compute architecture, a secure encrypted virtualization architecture (SEV) confidential compute architecture, or a Realm confidential compute architecture.

19. The non-transitory computer-readable storage medium of claim 17, wherein the IP firmware key is obtained from a secure arbitration module of the confidential compute architecture, wherein the secure arbitration module is to extend the IPL into a TD measurement register (MRTD), wherein the IPL extends the IP firmware into a runtime measurement register (RTMR), the MRTD and the RTMR providing evidence of the TD in a TD report, and wherein the TD report enables a security microcontroller to verify the IPL in the TD.

20. The non-transitory computer-readable storage medium of claim 17, wherein as part of the initialization process, the IP firmware to transmit a register programming script table to a secure arbitration module of the confidential compute architecture, the register programming script table to enable the secure arbitration module to perform the initialization process for the IP component.
